(19) United States
(12) Patent Application Publication
(10) Pub. No.: US 2002/0083361 A1
(43) Pub. Date: Jun. 27, 2002

(54) Home base user interface

(75) Inventors: James W. Brainard, Houston, TX (US); Norman P. Brown, Tomball, TX (US); Bradley V. Jung, Belmont, CA (US); Kitric S. Kerns II, San Jose, CA (US); Larry W. Kunkel, Houston, TX (US); Mark D. Moore, Palo Alto, CA (US); Michael A. Provencher, Houston, TX (US); Bradley A. Silen, Sausalito, CA (US)

Correspondence Address: CONLEY ROSE & TAYON, P.C., P. O. BOX 3267, HOUSTON, TX, 77253-3267, US

(73) Assignee: Compaq Information Technologies Group, L.P., Houston, TX

(21) Appl. No.: 10/083,900

(22) Filed: Feb. 27, 2002

Related U.S. Application Data
(63) Continuation of application No. 09/621,048, filed on Jul. 21, 2000.
Application No. 09/621,048 is a continuation of application No. 08/846,781, filed on Apr. 30, 1997.
Application No. 08/846,781 is a continuation-in-part of application No. 08/583,207, filed on Jan. 4, 1996, now abandoned.

(51) Int. Cl. G06F 11/00

(52) U.S. Cl. 714/2

(57) ABSTRACT

A method for aiding use of a computer includes receiving a home base signal, and in response to the home base signal, transferring control of the computer to a user home base application.

This application is a continuation-in-part of U.S. application Ser. No. 08/583,207, filed Jan. 4, 1996. Related applications are “FUNCTION SELECTION WITH HARDWARE BUTTON ARRAY ON COMPUTER CHASSIS” (P-1322) and “COMPUTER INTERFACE WITH HARDWARE BUTTON ARRAY” (P-1321), filed concurrently and incorporated by reference.

### BACKGROUND

This invention relates to computer interfaces.

Computer users find consistent interfaces helpful, particularly when hardware or software problems are encountered, or when a user becomes lost within an application. A consistent interface can reorient the user, allow recovery from problems, and guide the user when resuming operation. Such interfaces as Windows (TM) and OS/2 (TM) provide relatively consistent interfaces across a variety of software applications. These operating system interfaces are loaded from storage (usually a hard disk drive) and stored at least partly in RAM memory during operation.

### SUMMARY

In general, in one aspect, the invention features a method for aiding use of a computer, including receiving a home base signal, and in response to the home base signal, transferring control of the computer to a user home base application.

Embodiments of the invention may include the following features. The user home base application may be a persistent graphical interface to which a user may return to recover from an operating fault. The operating fault may be caused by a software application, the hardware of the computer, or by an operating system of the computer, and the operating fault may be the complete failure of the operating system. The user may launch a user application from the user home base application. The user home base application may have an interface that, when operating, has the same appearance under all operating conditions, providing-a level of comfort to a user operating the computer, and all operating conditions may include fault conditions caused by a software application, by the hardware of the computer, or by an operating system of the computer, and may be the complete failure of the operating system.

The home base signal may be generated by a dedicated manual switch, which may be a button, or may be associated with a computer keyboard, or with a game input device. The dedicated manual switch may be mounted in a computer housing. The home base signal may be generated by a software-provided graphical interface element, which may be a dialog input or a dialog button. The home base signal may be generated by a system interrupt, which may be generated in response to a failure of an operating system of the computer, in response to an action by a user, or when a user selects a software option.

The home base application may be software code stored in dynamic memory, stored partly in read-only memory and partly in non-volatile memory, or stored in read-only memory. The home base application may be a consistent interface display accessible from any of multiple user applications, and may be accessible both when an operating system of the computer is functioning and when the operating system has failed. The home base application may further include a low level home base application that engages when the operating system has failed, and a high level home base application that engages when the operating system is functioning. At least a part of the low level home base application may be located in a read-only memory.

The home base signal may be received by a system management interrupt handler, by a non-maskable interrupt handler, by a watchdog handler, by an operating system timer handler, or by a fail-safe home base loader. The receipt of the home base signal and the transfer of control to a home base application may be handled by a system management interrupt handler, a non-maskable interrupt handler, a watchdog handler, an operating system timer handler, and a fail-safe home base loader.

In general, in another aspect, the invention features a home base interface for a computer including a home base signal generator, a home base application provider, and a home base selector that engages the home base application provider upon receiving a home base signal from the home base signal generator.

Embodiments of the invention may include the following features. The home base signal generator may be a dedicated manual switch. The switch may be associated with a computer keyboard, or with a game input device. The switch may be mounted in a computer housing. The home base signal generator may be a software-provided graphical interface element, which may be a dialog input or a dialog button. The home base signal generator may be a system interrupt source. The system interrupt source may generate the home base signal in response to a failure of an operating system of the computer, in response to an action by a user, or when a user selects a software option.

The home base application provider may be software code stored in dynamic memory, stored partly in read-only memory and partly in non-volatile memory, or stored in read-only memory. The home base application provider may be a consistent interface display accessible from any of multiple user applications, and may be accessible both when an operating system of the computer is functioning and when the operating system has failed. The home base application provider may include a low level home base application that engages when the operating system has failed, and a high level home base application that engages when the operating system is functioning. At least a part of the low level home base application may be located in a read-only memory.

The home base selector may be a system management interrupt handler, a non-maskable interrupt handler, a watchdog handler, an operating system timer handler, or a fail-safe home base loader. The home base selector may include a system management interrupt handler, a non-maskable interrupt handler, a watchdog handler, an operating system timer handler, and a fail-safe home base loader.

In general, in another aspect, the invention features a home base interface for a computer including a home base signal generator, a home base application provider, and a home base selector that engages the home base application provider to provide a home base application upon receiving a home base signal from the home base signal generator, wherein the home base application-may be a consistent interface display accessible both when an operating system of the computer is functioning and when the operating system has failed.

Among the advantages of the invention are the following. A general purpose computer can display a consistent home base interface to which a user may return at any time. The consistent home base interface can be fashioned to survive a variety of software and hardware faults. The home base user interface ensures a high degree of confidence that the home base application can be accessed even when part or all of the operating environment has been corrupted or is no longer functioning. The consistent home base interface can be accessed by both hardware and software switches. A dedicated hardware home switch provides a safe, reliable tool for any user to find the home base interface. Users can rely on the consistent home base interface to provide a high level of comfort in operating the general purpose computer.

Other advantages and features of the invention will become apparent from the following description and from the claims.

### DESCRIPTION

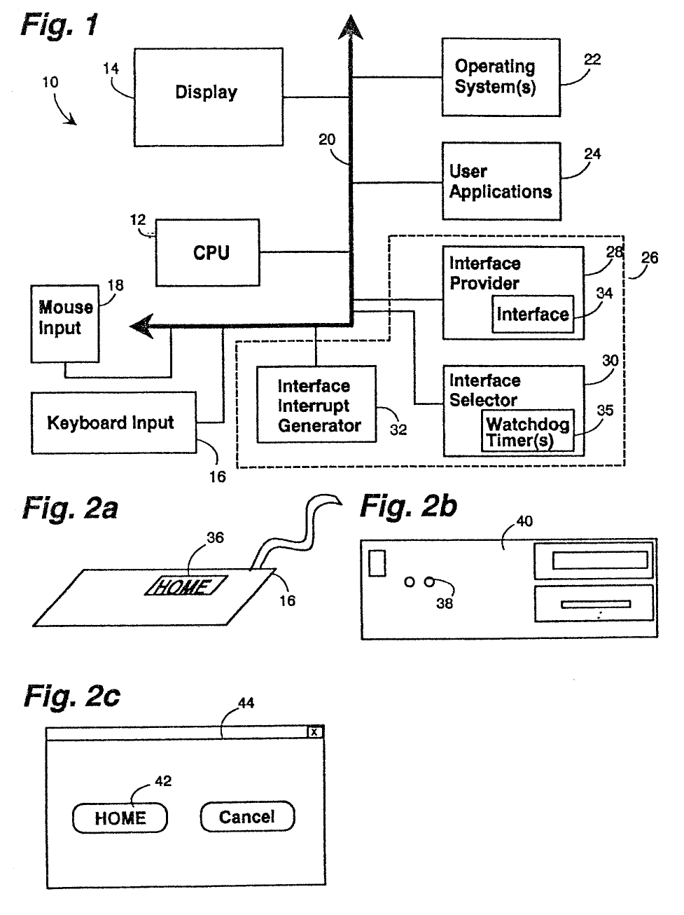

FIG. 1 is a representation of a computer providing a home base user interface.

FIGS. 2a, 2b, and 2c are diagrams of different implementations of a home key interface interrupt generator.

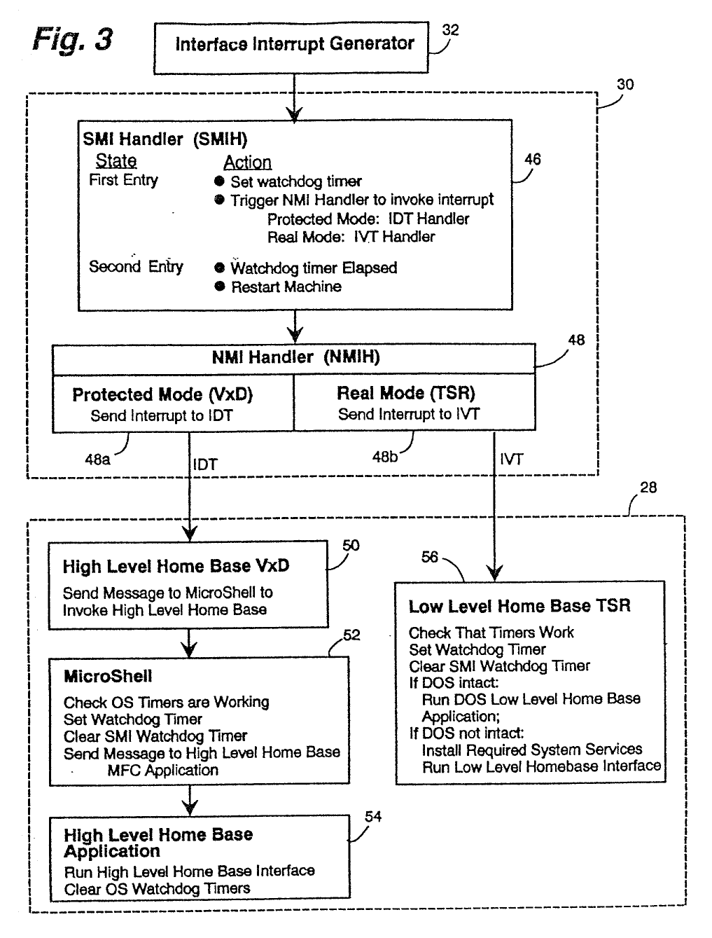

FIG. 3 is a schematic diagram of the components of a home base invocation system.

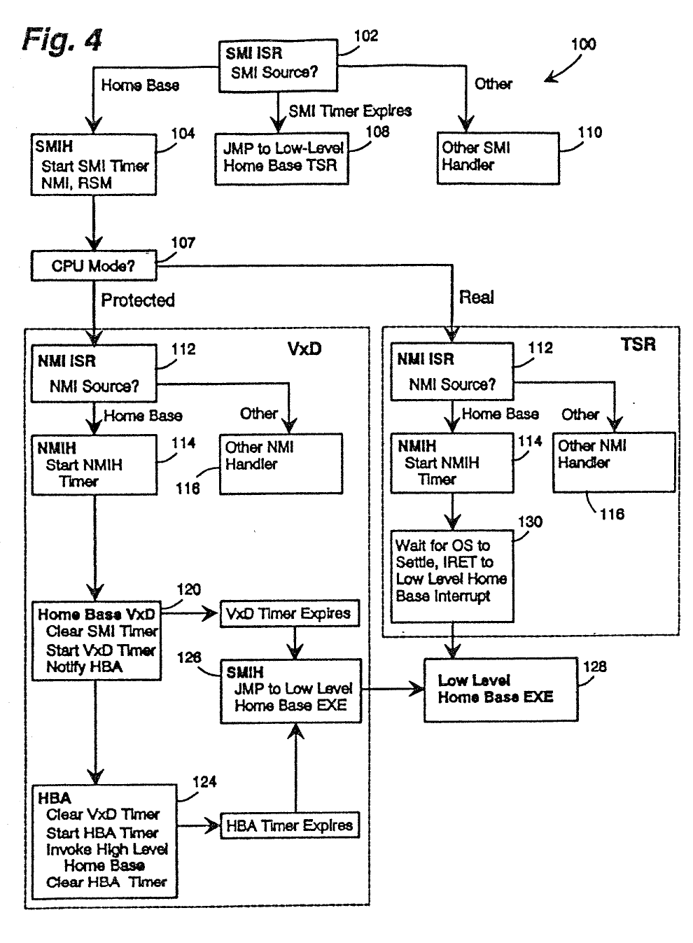

FIG. 4 is a flow chart showing the operation of the home base invocation system.

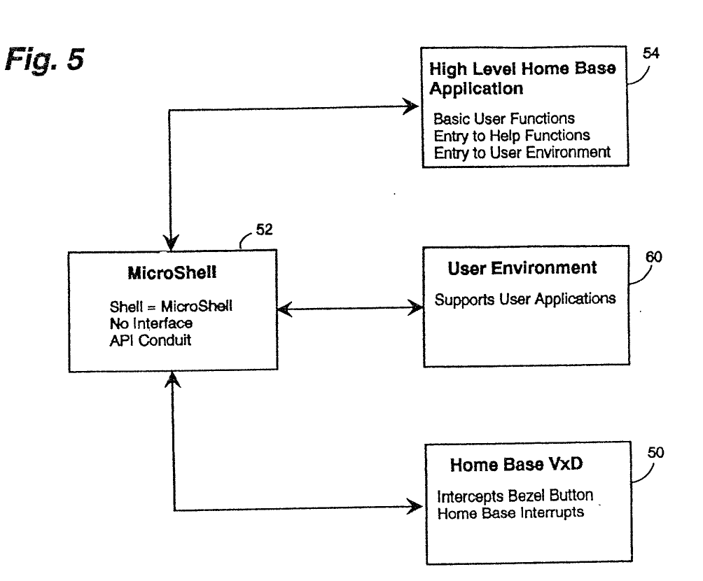

FIG. 5 is a schematic diagram of the relationship between the components of a high level home base application.

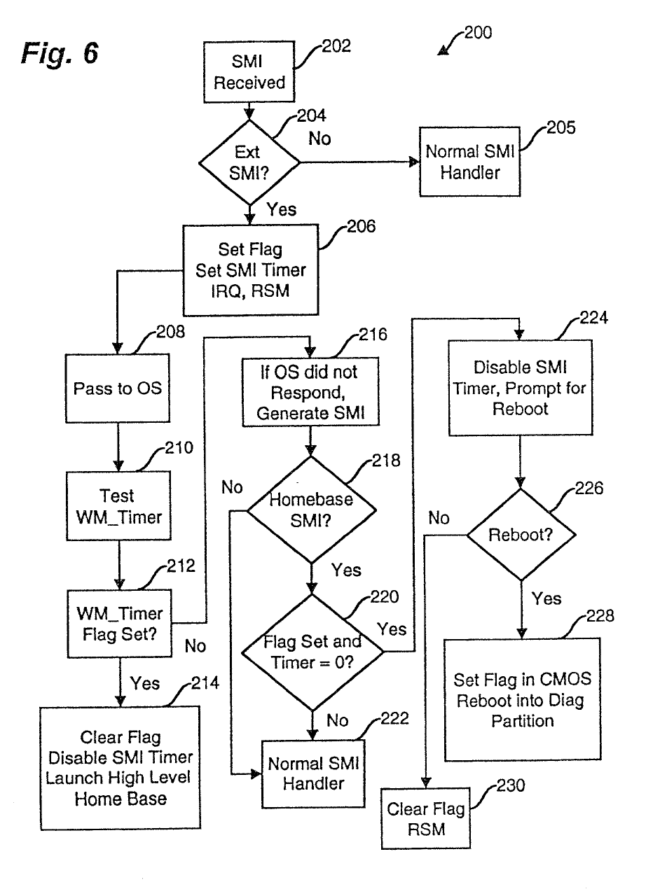

FIG. 6 is a flow chart showing the operation of an alternative home base invocation system.

Referring to FIG. 1, a computer 10 couples CPU 12, display 14, keyboard input 16, and mouse input 18 to one or more bus lines 20 carrying data and address information. CPU 12 accesses one or more operating systems 22 and user applications 24 stored temporarily in RAM and more permanently in other media (e.g., ROM, a hard drive, removable magnetic, optic or magneto-optic media, etc.). Operating system(s) 22 and user applications 24 provide one or more environments for a user of computer 10 to perform various tasks (e.g., do work, play games, produce documents, etc.). Operating system 22 and user applications 24 can be graphically based (e.g., Windows and/or Macintosh-based programs).

A home base user interface 26 includes three components: a home base interface provider 28, an interface selector 30, and an interface interrupt generator 32. Interface provider 28 generates a consistent home base user interface 34, e.g., a simple graphical interface that provides a set of straightforward system commands for a user. Home base user interface 34 may, for example, be constructed to allow selective entry into one or more different operating systems 22 and/or user applications 24. Home base user interface 34 can provide help to a user when computer 10 has otherwise “crashed” or ceased higher-level functions. Home base user interface 34 may provide users with a comforting area that can be accessed under nearly any condition. Users may employ home base user interface 34 as a starting point for any particular use of computer 10, and as a place to which users can nearly always return.

Interface selector 30 causes interface provider 28 to display, and turn control over to, home base user interface 34 under selected conditions. One such condition is when interface interrupt generator 32 has issued an interface interrupt signal. This can occur when a user has pressed a selected button or key combination. Referring to FIGS. 2a through 2c, a variety of dedicated “home” interface keys or buttons can be designed. As in FIG. 2a, a specific dedicated key on computer keyboard 16 can be constructed to provide a specific home signal. One scheme for implementing such a dedicated key is described in U.S. patent application Ser. No. 08/582,755, entitled “Computer Keyboard”, filed on the same day as this application and incorporated by reference. Or, referring to FIG. 2b, a specific home bezel button switch 38 can be constructed on the front panel of the computer's housing 40, coupled to computer bus line 20 (in one embodiment, the button switch can couple directly to a Pentium-family processor system management interrupt line). Upon depressing home bezel switch 38, a user can signal an interface interrupt. Or, as in FIG. 2c, software applications can include home buttons 42 within dialog boxes 44 (or other similar input schemes, e.g., pull-down menus) where a user desiring to return to home base interface 34 can send an appropriate interface signal. The interface signal can also be generated automatically under certain system events, e.g., the sudden loss of the operating system, or other system failure.

Referring to FIGS. 3 and 4, in one implementation, interface selector 30 and interface provider 28 have several components. Interface selector 30 employs a system management interrupt handler (SMIH) 46 and a non-maskable interrupt handler (NMIH) 48. SMIH 46 traps a system management interrupt selected as the home base interface interrupt. NMIH is implemented as two parallel devices: a protected-mode VxD 48a, and a real mode TSR 48b. NMIH handles the non-maskable interrupt sent by SMIH 46, where the NMI has been transferred either by the interrupt dispatch table IDT (under protected mode) or the interrupt vector table IVT (under real mode).

Interface provider 28 includes two versions of the home base interface, a High Level Home Base Application 54 (with its associated applications: High Level Home Base VxD 50 and Home Base MicroShell 52) and a Low Level Home Base Application 56 (e.g., a DOS EXE program). High Level Home Base VxD 50 is activated if the system is in protected mode and the interrupt has been handled by the IDT; when CPU 12 is in real mode, Low Level Home Base Application TSR 56 is activated via the IVT.

Home base invocation system 26 provides a mechanism where control initiated by some “home” event (e.g., depressing the home button 36) cascades from highest to lowest systems. A home base application is invoked at the highest operating system level still intact. For example, if Windows still functions, High Level Home Base Application 54 is invoked; if Windows has crashed, but DOS still functions, Low Level Home Base DOS application 56 begins.

The first time SMIH 46 encounters the interface interrupt (“first entry”), it sets an SMI watchdog timer 35, (all timers 35 may be implemented in hardware on the motherboard, and may be borrowed from an existing hardware timer 35) and generates an NMI handled by NMIH 48. CPU mode forces that interrupt to be handled either along the IDT or IVT path. If the system is operating in protected mode, VxD NMIH 48a attempts to start High Level Home Base Application 54. VxD NMIH 48 starts an operating system watchdog timer 35. NMIH 48a checks to make sure that operating system timers are operating, sets a home base application operating system watchdog timer 35, clears the SMI watchdog timer 35 set by SMIH 46 (indicating that operating system timers are intact and can be relied upon to signal a failure to load the High Level Home Base Application (described below), and returns operation to the prior context. If possible, NMIH 48 should boost the priority level of High Level Home Base Application 54 so that it executes as soon as possible.

NMIH 48a is coupled to High Level Home Base VxD 50 which messages Home Base MicroShell 52 with a high level operating system message. MicroShell 52 then brings High Level Home Base Application 54 to the front, or launches an instance of the application. All VxD components (e.g., NMIH 48a and High Level Home Base VxD 50) can, for convenience, be part of one VxD driver.

Referring to FIG. 5, Home Base MicroShell 52 acts as a non-displayed shell application governing transfer of messages and control among High Level Home Base Application 54 (providing basic user functions), High Level Home Base VxD 50 (which intercepts Home button presses (e.g., from bezel button 38), and other home base interrupts (e.g., from software selections 42)), and one or more user environments 60 which may be entered from High Level Home Base Application 54. Home Base MicroShell 52 is a windowless application set as the shell, in one implementation, with the Windows “SHELL=” command. Home Base MicroShell 52 also serves as a central messaging API for a variety of messages, including: a signal to make High Level Home Base Application 54 the frontmost application, a message to launch a specific user environment 60, and messages to tell a current environment to close.

High Level Home Base Application 54 may include a robust animated interface (employing, e.g., 16-bit color graphics), may remain static across time so to become familiar and comfortable to the user, and may support a wide range of screen resolutions.

If any of the watchdog timers 35 expire before being cleared, (indicating that for some reason, High Level Home Base Application 54 is not available, due to some hardware or software failure), SMIH 46 is engaged again. Upon the second entry, SMIH 46 triggers TSR NMIH 48b to generate an IVT interrupt even if computer 10 is in protected mode. Low Level Home Base TSR 56 checks that basic computer timers operate, sets a watchdog timer 35, determines whether the low-level operating system (e.g., DOS) is intact, and clears the recent SMIH timer 35. If so, a Low Level DOS Home Base application is run. The Low Level DOS Home Base application may provide limited functionality such as allowing system shutdown, a return to DOS (if running), and limited help.

If DOS is not intact, a very Low Level home base interface is run. In this extreme circumstance, the SMI might set a CMOS flag and force a hard reset of the machine, forcing computer 10 to boot into the Low Level Home Base application. The system reset may be done such that the user is unaware of this step, and loads a system of basic support, passing execution to the Low Level Home Base interface. The Low Level Home Base interface can display a minimal image of DOS, along with the Low Level Home Base image (which can mimic the image of the High Level Home Base interface and/or the Low Level DOS Home Base Interface, but not provide as many services or features).

Depending on available computer resources a portion or all of interface selector 30 and interface provider 28 can be placed into non-volatile ROM on the system motherboard of computer 10. One implementation places all required code in ROM and couples the HOME interface button 38 directly to the motherboard as well. In this way, a user should be able to enter the home interface even if all peripherals, including the hard drive (or other dynamic storage media), have been disabled. Another implementation places a kernel of code, particularly that required by SMIH 46 and NMIH 48 in ROM, using a reset into a protected area of dynamic storage (e.g., a protected area, or private disk partition, of a hard disk drive) for the rest of the code. Another implementation places appropriate code in software stored on a disk drive, and then in RAM upon booting up computer 10.

For different operating systems, the various components of the home base interface 26 may be provided in different ways. Under DOS, some of the modules (NMIH, and home base applications) can be implemented as TSRs, with the SMIH implemented in BIOS. Under a Windows environment, the modules (except for the SMIH) could be implemented as VxDs. High Level Home Base Application 54 may be a straightforward Windows application.

Referring to flow chart 100 of FIG. 4, when a system management interrupt occurs (step 102), its source determines its effect: if it is a home base interface interrupt (caused, e.g., by a user pressing bezel button 38), operation is passed to SMIH 48 (step 104) which starts its own watchdog timer 35 and sets a nonmaskable interrupt, and returns operation to the operating system. If the SMI source was a failure of the SMIH watchdog timer 35, a jump is made (step 108) immediately to Low Level Home Base TSR 56, since something prevented SMIH from loading any Home Base Application gracefully. If the SMI is from some other source, it is passed to its appropriate handler (step 110).

Once SMIH 46 has generated an NMI, an NMI service routine (which can be considered part of NMIH 48) determines (step 112) whether the NMI originated with SMIH 46, and if so, engages NMIH 48 (step 114). If not, the NMI should be handled by some other NMI handler (step 116). In real mode NMIH 48b waits for the operating system to settle, then performs an interrupt return to Low Level Home Base TSR to invoke the Low Level Home Base DOS interface (step 130). One implementation waits until the INDOS flag clears to ensure that DOS is not in the middle of a critical or I/O operation when Home Base takes control of CPU 12. In protected mode, NMIH 48a (through Home Base VxD 120) (step 120) sends a high level operating system message to MicroShell 52. At this point, the Home Base Application system attempts to load High Level Home Base Application 54.

Whether in protected or real mode, the SMI watchdog timer 35 is not cleared by any further layer until that layer can verify that the respective operating system (e.g., Windows or DOS) is functioning and that a new timer can be and has been set. Thus, each level passes the baton as far down the operating system ladder as possible, ensuring that some form of a home base application will be loaded.

Once High Level Home Base Application 54 (with its associated MicroShell 52) are engaged (step 124), they clear the VxD timer 35, start an Home Base Application (HBA) timer 35, and invoke the High Level Home Base Application 54. Once High Level Home Base Application 54 is operating, the HBA timer 35 is cleared. If, instead the HBA timer 35 expires first (or the VxD timer 35 expires), then a jump is made to the Low Level Home Base executable application (steps 126 and 128).

Referring to FIG. 6, an alternative home base invocation system 200 engages upon receipt of an SMI (step 202). If the SMI is not external (decision step 204), the SMI is passed on to normal SMI handler routines (step 205). If the SMI is an external (home base) SMI, which has also set an interrupt request (IRQ), a home base flag is set, an SMI timer is started (step 206), and control is passed to the operating system (via an NMI) to initiate the high level home base application (step 208).

The operating system (e.g., Windows®) is then tested to ensure that it is correctly handling messaging routines by using, e.g., the Windows® message timer WM_timer (step 220). If, within a set time period, WM_timer returns with its flag set (step 212), the operating system is handling messages in a timely fashion, and control is then passed to the high level home base application (step 214), which then clears the home base flag, disables the home base SMI timer, and launches the full high level home base application.

If WM_timer does not timely return with its flag set, or the operating system fails to launch the high level home base application for any other reason (indicating that in all probability, the operating system is not properly functioning), and another SMI is generated (step 216). If it is not a true home base SMI (step 218), control is passed to a normal SMI handler (step 222). If (as is more likely the case) the newly-generated SMI is due to a failure to load the high level home base application (as can be ascertained if the home base flag has been set, but the original hardware SMI timer has run out (step 220)), the SMI timer is then disabled, and the user is prompted to reboot the system (step 224) due to a failure of the operating system. In some embodiments, the system can simply reboot automatically, but this can be somewhat alarming to a computer user. If the user elects to reboot (step 226), then a home base flag is set in the BIOS CMOS of the computer motherboard, and the computer is rebooted into the diagnostics partition (DIAG) of the boot drive (step 228). The diagnostics partition can contain some or all of the low level home base application discussed above. If the user chooses not to reboot, the home base flag is cleared, and operation is resumed from system management (RSM) (step 230).

Other embodiments are within the scope of the following claims. For example, a number of different signal sources can trigger entry into the home base user interface, including dedicated buttons, key stroke combinations, mouse clicks, dialog box indicators, voice recognition techniques, and pen stroke gestures. The interface provider, interface selector, and interface interrupt generator modules can be combined into a single module with the same functions, or may be disaggregated. The system management interrupt and mode provided by Intel's Pentium microprocessor can be replaced with any microprocessor services that allow invoking processes through button presses and/or monitored timers. The home base user interface may be used on any number of hardware platforms, including Intel, Motorola, PowerPC, or RISC-based microprocessors, and on any number of software platforms including DOS, Windows, Macintosh, and UNIX.

What is claimed is:

1. A method for aiding use of a computer, comprising:
receiving a home base signal, and
in response to the home base signal, transferring control of the computer to a user home base application.

2. The method of claim 1 wherein the user home base application is a persistent graphical interface to which a user may return to recover from an operating fault.

3. The method of claim 2 wherein the operating fault was caused by a software application.

4. The method of claim 2 wherein the operating fault was caused by the hardware of the computer.

5. The method of claim 2 wherein the operating fault was caused by an operating system of the computer.

6. The method of claim 5 wherein the operating fault is the complete failure of the operating system.

7. The method of claim 2 wherein the user may launch a user application from the user home base application.

8. The method of claim 2 wherein the user home base application has an interface that, when operating, has the same appearance under all operating conditions, providing a level of comfort to a user operating the computer.

9. The method of claim 8 wherein all operating conditions includes fault conditions caused by a software application.

10. The method of claim 8 wherein all operating conditions includes fault conditions caused by the hardware of the computer.

11. The method of claim 8 wherein all operating conditions includes faults caused by an operating system of the computer.

12. The method of claim 11 wherein the fault is the complete failure of the operating system.

13. The method of claim 1 wherein the home base signal is generated by a dedicated manual switch.

14. The method of claim 13 wherein the dedicated manual switch comprises a button.

15. The method of claim 13 wherein the dedicated manual switch is associated with a computer keyboard.

16. The method of claim 13 wherein the dedicated manual switch is associated with a game input device.

17. The method of claim 13 wherein the dedicated manual switch is mounted in a computer housing.

18. The method of claim 1 wherein the home base signal is generated by a software-provided graphical interface element.

19. The method of claim 18 in which the interface element comprises a dialog input

20. The method of claim 19 in which the interface element comprises a dialog button.

21. The method of claim 1 wherein the home base signal is generated by a system interrupt.

22. The method of claim 21 wherein the system interrupt is generated in response to a failure of an operating system of the computer.

23. The method of claim 21 wherein the system interrupt is generated in response to an action by a user.

24. The method of claim 21 wherein the system interrupt is generated when a user selects a software option.

25. The method of claim 1 wherein the home base application comprises software code stored in dynamic memory.

26. The method of claim 1 wherein the home base application comprises software code stored partly in read-only memory and partly in non-volatile memory.

27. The method of claim 1 wherein the home base application comprises software code stored in read-only memory.

28. The method of claim 1 wherein the home base application comprises a consistent interface display accessible from any of multiple user applications.

29. The method of claim 1 wherein the home base application comprises a consistent interface display accessible both when an operating system of the computer is functioning and when the operating system has failed.

30. The method of claim 29 wherein the home base application further comprises
a low level home base application that engages when the operating system has failed; and
a high level home base application that engages when the operating system is functioning.

31. The method of claim 30 wherein at least a part of the low level home base application is located in a read-only memory.

32. The method of claim 1 wherein the home base signal is received by a system management interrupt handler.

33. The method of claim 1 wherein the home base signal is received by a non-maskable interrupt handler.

34. The method of claim 1 wherein the home base signal is received by a watchdog handler.

35. The method of claim 1 wherein the home base signal is received by an operating system timer handler.

36. The method of claim 1 wherein the home base signal is received by a fail-safe home base loader.

37. The method of claim 1 wherein the receipt of the home base signal and the transfer of control to a home base application is handled by:
a system management interrupt handler;
a non-maskable interrupt handler;
a watchdog handler;
an operating system timer handler; and
a fail-safe home base loader.

38. A home base interface for a computer comprising:
a home base signal generator;
a home base application provider; and
a home base selector that engages the home base application provider upon receiving a home base signal from the home base signal generator.

39. The apparatus of claim 38 wherein the home base signal generator comprises a dedicated manual switch.

40. The apparatus of claim 39 wherein the switch is associated with a computer keyboard.

41. The apparatus of claim 39 wherein the switch is associated with a game input device.

42. The apparatus of claim 39 wherein the switch is mounted in a computer housing.

43. The apparatus of claim 38 wherein the home base signal generator comprises a software-provided graphical interface element.

44. The apparatus of claim 43 wherein the interface element comprises a dialog input.

45. The apparatus of claim 44 wherein the dialog input comprises a dialog button.

46. The apparatus of claim 38 wherein the home base signal generator comprises a system interrupt source.

47. The apparatus of claim 46 wherein the system interrupt source generates the home base signal in response to a failure of an operating system of the computer.

48. The apparatus of claim 46 wherein the system interrupt source generates the home base signal in response to an action by a user.

49. The apparatus of claim 46 wherein the system interrupt source generates the home base signal when a user selects a software option.

50. The apparatus of claim 38 wherein the home base application provider comprises software code stored in dynamic memory.

51. The apparatus of claim 38 wherein the home base application provider comprises software code stored partly in read-only memory and partly in non-volatile memory.

52. The apparatus of claim 38 wherein the home base application provider comprises software code stored in read-only memory.

53. The apparatus of claim 38 wherein the home base application provider comprises a consistent interface display accessible from any of multiple user applications.

54. The apparatus of claim 38 wherein the home base application provider comprises a consistent interface display accessible both when an operating system of the computer is functioning and when the operating system has failed.

55. The apparatus of claim 54 wherein the home base application provider further comprises:
a low level home base application that engages when the operating system has failed; and
a high level home base application that engages when the operating system is functioning.

56. The apparatus of claim 55 wherein at least a part of the low level home base application is located in a read-only memory.

57. The apparatus of claim 38 wherein the home base selector further comprises a system management interrupt handler.

58. The apparatus of claim 38 wherein the home base selector further comprises a non-maskable interrupt handler.

59. The apparatus of claim 38 wherein the home base selector further comprises a watchdog handler.

60. The apparatus of claim 38 wherein the home base selector further comprises an operating system timer handler.

61. The apparatus of claim 38 wherein the home base selector further comprises a fail-safe home base loader.

62. The apparatus of claim 38 wherein the home base selector further comprises:
a system management interrupt handler;
a non-maskable interrupt handler;
a watchdog handler;
an operating system timer handler; and
a fail-safe home base loader.

63. A home base interface for a computer comprising:
a home base signal generator;
a home base application provider; and
a home base selector that engages the home base application provider to provide a home base application upon receiving a home base signal from the home base signal generator, wherein the home base application comprises a consistent interface display accessible both when an operating system of the computer is functioning and when the operating system has failed.
